(19) United States
(12) Patent Application Publication
(10) Pub. No.: US 2013/0021437 A1
(43) Pub. Date: Jan. 24, 2013

(54) Apparatus, System and Method for Recording a Multi-View Video and Processing Pictures, and Decoding Method

(71) Applicant: Huawei Device Co., Ltd, Shenzhen (CN)

(72) Inventor: Yuan LIU, Shenzhen (CN)

(73) Assignee: Huawei Device Co., Ltd., Shenzhen (CN)

(21) Appl. No.: 13/630,347

(22) Filed: Sep. 28, 2012

Related U.S. Application Data
(63) Continuation of application No. 12/823,777, filed on Jun. 25, 2010.
Application No. 12/823,777 is a continuation of application No. PCT/CN2008/073522, filed on Dec. 16, 2008.

(51) Int. Cl. H04N 13/02; H04N 7/26

(52) U.S. Cl. 348/43; 348/E13.074

(57) ABSTRACT

An apparatus, a system, and a method for recording a multi-view video and processing images, and a decoding method are disclosed. The apparatus for recording a multi-view video and processing images includes a video recording unit, a collecting unit, a selecting unit, and an encoding unit, which are connected in sequence. The video recording unit is configured to record a video including recording a multi-view video, and output 3D video data. The collecting unit is configured to collect 3D video data output by the video recording unit. The selecting unit is configured to select at least one channel of data among the 3D video data. The encoding unit is configured to encode data including encoding the 3D video data selected by the selecting unit.

### CROSS-REFERENCE TO RELATED APPLICATIONS

This application is a continuation of U.S. patent Ser. No. 12/823,777, filed on Jun. 25, 2010, which is a continuation of an International Application No. PCT/CN2008/073522, filed Dec. 16, 2008, which designated the United States and was not published in English, and which claims priority to Chinese Application No. 200710305690.1, filed Dec. 28, 2007, all of which applications are incorporated herein by reference.

### TECHNICAL FIELD

The present invention relates to video processing, and in particular, to an apparatus, a system, and a method for recording a multi-view video and processing images, and a decoding method.

### BACKGROUND OF THE INVENTION

Three-dimensional (3D) video technology may provide images that comply with 3D visual principles and have depth information, so the views of the objective world are veritably reproduced, and authenticity and senses of depth and hierarchy of scenes are presented. 3D video technology is an important trend of current video technologies.

Two main research hot spots in the current video research field are: binocular 3D video, and Multi-View Coding (MVC) video. The basic principles of the binocular 3D video are: simulating principles of human eye imaging, using two video cameras to obtain the left eye image and the right eye image independently, letting the left eye of a person see the left eye path image and letting the right eye of the person see the right eye path image, and finally synthesizing the images to obtain 3D images. An MVC video is obtained by multiple video cameras to record a video simultaneously from different angles, and has multiple video paths. At the time of playing the video, the scene images at the different angles are sent to a user terminal such as a television screen. When watching the video, the user can select different angles to watch different scene images.

The conventional art discloses a method and a device for multiplexing multi-view 3D motional images according to requirements of a user. In this method, the motional images collected by the multi-view video cameras are encoded and multi-view encoded streams are generated, reverse channel information of the user is received and proper encoded streams are selected according to the information to perform synchronous multiplexing according to frames or scenes. The method includes:

Step 101: Obtain motional images and information from multiple video cameras, and generate multiple multi-view encoded streams.

Step 102: Receive view information and the user-selected display mode information from reversed channels.

Step 103: According to the reversed channel information, select a group of encoded streams among the multi-view encoded streams for multiplexing in a frame-by-frame manner or in a scene-by-scene manner, where every stream has the same time information.

The foregoing MVC technology uses multiple video cameras to obtain image data for the same scene from different view angles at a same time, encodes all the image data, and then selects one group of encoded streams for multiplexing among the multi-view code streams. The encoding consumes plenty of encoding resources, the encoding is very time consuming, and the required encode processing capability of the system is very high.

### SUMMARY OF THE INVENTION

The embodiments of the present invention provide an apparatus, a system, and a method for recording a multi-view video and processing images, and a decoding method to improve efficiency of collecting and encoding multi-view images and lower the requirement of processing capability of the system.

An apparatus for recording a multi-view video and processing images includes a video recording unit, a collecting unit, a selecting unit, and an encoding unit, which are connected in sequence. The video recording unit is configured to record a multi-view video and output 3D video data. The collecting unit is configured to collect 3D video data output by the video recording unit. The selecting unit is configured to select at least one channel of the 3D video data among the 3D video data. The encoding unit is configured to encode data including the 3D video data selected by the selecting unit.

An apparatus for decoding a multi-view video, processing and displaying images includes an input control unit configured to send instructions, including sending an instruction of recording a video at a specified view angle, and a decoding unit configured to decode data which are obtained from video recording at the specified view angle and encoded.

A system for recording a multi-view video and processing images includes an apparatus for recording a multi-view video and processing images and an apparatus for decoding a multi-view video, processing and displaying images which is interconnected with the apparatus for recording a multi-view video and processing images. The apparatus for recording a multi-view video and processing images is configured to record a multi-view video, output three-dimensional (3D) video data, select at least one channel of data among the 3D video data, encode the at least one channel of data, and send the encoded at least one channel of data to an apparatus for decoding a multi-view video, processing and displaying images. The apparatus for decoding a multi-view video, processing and displaying images is configured to send an instruction of recording a video at a specified view angle to the apparatus for recording a multi-view video and processing images, and decode the encoded at least one channel of data sent by the apparatus for recording a multi-view video and processing images.

A method for recording a video and processing images includes recording a multi-view video and outputting 3D video data, selecting at least one channel of data among the 3D video data, and encoding the selected 3D video data.

A method for decoding a video and processing images includes inputting information about a view angle of a user and distance between the user and the display surface, and decoding received 3D video data, and reconstructing images out of the decoded 3D video data according to the information about the view angle and distance, obtaining images suitable for the user to watch, and displaying the images.

As can be seen from the above technical solutions, unlike the conventional art which encodes video data photographed at all view angles and makes the system bear a heavy load, technical solutions of the present invention encode only the video streams as required, or encode only the video streams as indicated by an input instruction for designating a view angle, thus simplifying the collection and/or encoding, improving efficiency of collection and encoding, and reducing the requirement of processing capability of the system.

### BRIEF DESCRIPTION OF THE DRAWINGS

FIG. 1 is a flowchart of a method for multiplexing multi-view 3D motional images in the conventional art;

FIG. 2 is a schematic diagram of an apparatus for recording a multi-view video and processing images in the first embodiment of the present invention;

FIG. 3 is a schematic diagram of an apparatus for recording a multi-view video and processing images in the second embodiment of the present invention;

FIG. 4 is a schematic diagram of an apparatus for decoding a multi-view video, processing and displaying images in the first embodiment of the present invention;

FIG. 5 is a schematic diagram of a system for recording a multi-view video and processing images in the first embodiment of the present invention;

FIG. 6 shows working principles of a system for recording a multi-view video and processing images in the first embodiment of the present invention;

FIG. 7 shows relationships between image parallax, object depth, and user-display distance under a parallel video camera system;

FIG. 8 is an overall working diagram of a system for recording a multi-view video and processing images in an embodiment of the present invention;

FIG. 9 is a flowchart of video collection and encoding shown in FIG. 8;

FIG. 10 shows working principles of an apparatus for recording a video and processing images in an embodiment of the present invention;

FIG. 11 is a flowchart of a method for recording a video and processing images in the first embodiment of the present invention; and

FIG. 12 is a flowchart of a method for decoding videos and processing images in the first embodiment of the present invention.

### DETAILED DESCRIPTION OF THE INVENTION

In order to make the technical solution, objectives, and merits of the present invention clearer, the following describes the embodiments of the present invention in more detail with reference to accompanying drawings.

One aspect of the present invention is to control operations of recording a multi-view video and processing images, select some of the view angles for video recording in the multi-view video recording operation according to the view angle requirement, or select video data of part of view angles among multiple-channel video data obtained from the video recording according to the view angle requirement, or adjust the recording angle of the video camera according to the view angle requirement, or select reconstructible video data recorded at two view angles according to the view angle requirement, and then encode the video data obtained from the recording, in order to improve efficiency of collection and encoding and lower the requirement of processing capability of the system.

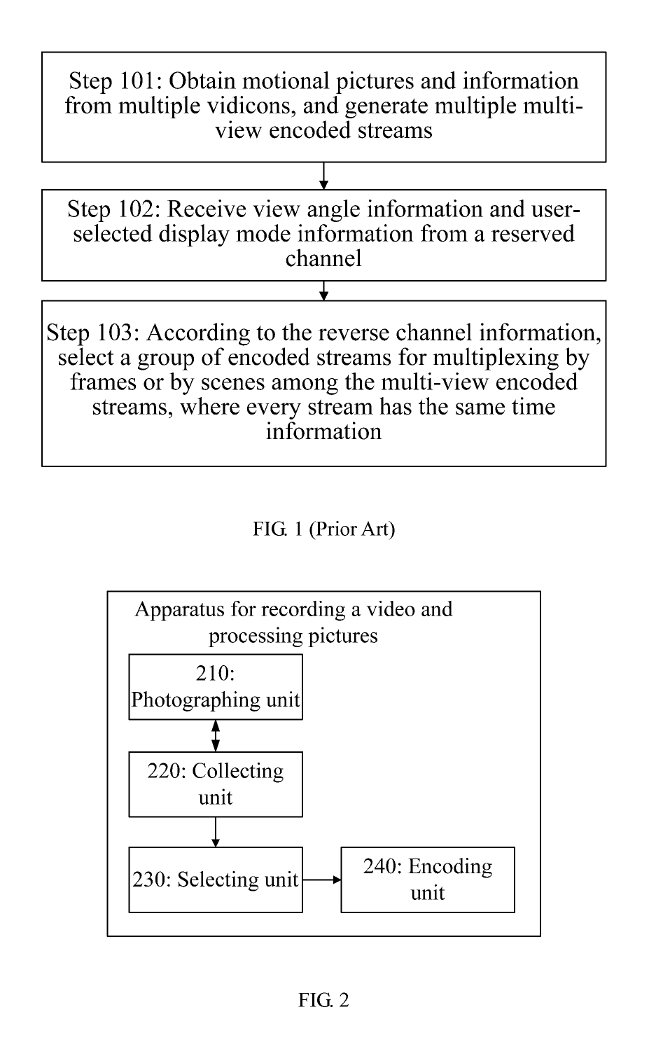

FIG. 2 is a schematic diagram of an apparatus for recording a multi-view video and processing images in the first embodiment of the present invention. The apparatus includes a video recording unit 210, a collecting unit 220, a selecting unit 230, and an encoding unit 240, which are connected in sequence.

The video recording unit 210 is configured to record a video, including recording a multi-view video, and producing 3D video data.

The collecting unit 220 is configured to collect the 3D video data produced by the video recording unit.

The selecting unit 230 is configured to select at least one channel of data among the 3D video data.

The encoding unit 240 is configured to encode data, including the 3D video data selected by the selecting unit 230.

As can be seen from the above embodiment, unlike the conventional art according to which encoding video data recorded at all view angles unselectively to cause the system bear a heavy load, the embodiment of the present invention selects part of the video streams for encoding by the selecting unit 230 according to the instruction for designating a view angle sent by the user in multi-view video recording. Thus complexity of collecting and/or encoding can be efficiently reduced, efficiency of collection and encoding is improved, and the requirement for processing capability of the system is reduced.

In other embodiments, the selecting unit 230 is configured to match the view angle information of each channel of data with the view angle carried in the instruction for designating a view angle one by one according to the received instruction for designating the view angle, and obtain at least one channel of 3D video data corresponding to the specified view angle.

In other embodiments, the selecting unit 230 is integrated in the video recording unit 210, collecting unit 220, or encoding unit 240.

The encoding content of the encoding unit 240 includes at least one of the following: original video data; original video data and parallax data or depth data; and original video data, parallax data or depth data and residual data.

The parallax data or depth data and the residual data may be collected by the video recording unit 210 capable of recording a 3D video, or, the video recording unit 210 incapable of collecting this information may collect video data first, and then send the collected video data together with parallax data or depth data and residual data collected additionally to the encoding unit 240.

The encoding unit 240 may be configured to encode 3D video data in an encoding mode corresponding to the received instruction of the view angle of the user to watch and the received instruction of the display mode of a display unit which displays the 3D video data, where the display mode may include two-dimensional (2D) display, binocular 3D video display, or multi-view video display.

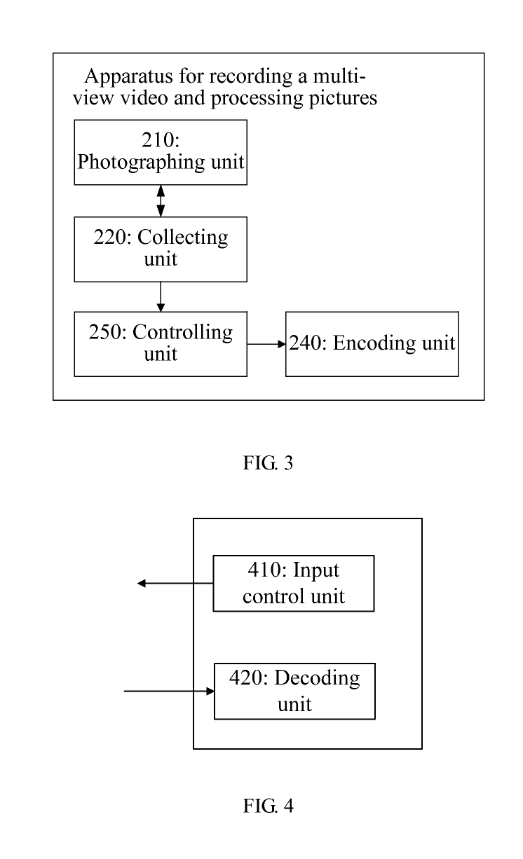

Referring to FIG. 3, an apparatus for recording a multi-view video and processing images is provided. This apparatus is similar to the apparatus for recording a multi-view video and processing images in the above first embodiment. In this embodiment, the selecting unit is configured to control the video recording unit to record a video at the specified view angle according to the received instruction for designating a view angle, and obtain at least one channel of data. The selecting unit in this embodiment is called a control unit to be different from the above apparatus for recording a multi-view video and processing images in the first embodiment. The apparatus in this embodiment includes a video recording unit 210, configured to record a video, including recording a multi-view video, and output 3D video data, a collecting unit 220 configured to collect the 3D video data output by the video recording unit 210, a control unit 250 configured to control the video recording unit 210 to record a video at a specified view angle according to the received instruction for designating a view angle, and an encoding unit 240 configured to encode data, including encoding the 3D video data output by the collecting unit 220.

In other embodiments, the control unit 250 may be integrated in the video recording unit 210 or collecting unit 220.

The control unit 250 may be further configured to control the video camera corresponding to the specified view angle of the video recording unit 210 to record a video according to the received instruction for designating a view angle, and output the 3D video data; or control the video camera of the video recording unit 210 and let the video camera adjust itself to record a video at the specified view angle according to the received instruction for designating a view angle, and output the 3D video data; or control the video camera close to the specified view angle to record a video according to the received instruction for designating a view angle, and output the 3D video data.

The collecting unit 220 may send the data obtained from video recording of the video camera close to the specified view angle, an internal parameter and an external parameter of each video camera, and a collection timestamp to the encoding unit 240.

The collecting unit 220 may further include a image processing unit configured to reconstruct the data obtained from video recording of the video camera close to the specified view angle, obtain virtual view angle data, and send the virtual view angle data to the encoding unit 240.

Referring to FIG. 4, an apparatus for decoding a multi-view video, processing and displaying images is provided. The apparatus includes an input control unit 410, configured to send instructions, including an instruction of recording a video at a specified view angle, and a decoding unit 420, configured to decode the data encoded and obtained by video recording at the specified view angle.

In this embodiment, the display side sends an instruction of recording a video at a specified view angle to the video collection side so that the video collection side only collects the images at the specified view angle, thus reducing the encoding load and the decoding load.

In other embodiments, the decoding unit 420 is configured to decode 3D video data in the corresponding decoding mode according to the received instruction of the view angle of the user to watch and the received instruction of the display mode of the display unit which displays the 3D video data, where the display mode may include 2D display, binocular 3D video display, or multi-view video display.

The input control unit 410 sends an instruction of recording a video at the specified view angle to the video recording unit 210 on the video collection side, and may further send information about distance from the user to the display surface. This embodiment overcomes the problem that location transfer brings parallax change when the user watches the 3D image through a 3D display.

The input control unit 410 above may be located in the video recording side or in the remote display side. When the input control unit 410 is located in the remote display side, the instruction of recording a video at the specified view angle may be sent over the network to the apparatus for recording a video and processing images.

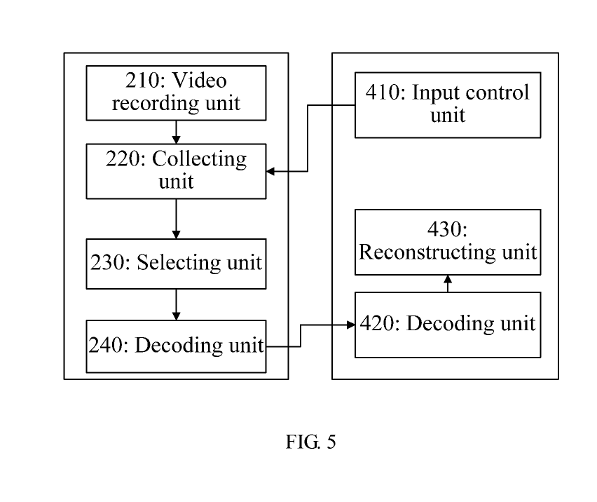

FIG. 5 provides a system for recording a multi-view video and processing images. The system includes an apparatus for recording a multi-view video and processing images and an apparatus for decoding a multi-view video, processing and displaying images.

The apparatus for recording a multi-view video and processing images includes a video recording unit 210, configured to: record a video, including recording a multi-view video, and outputting 3D video data, a collecting unit 220, configured to collect the 3D video data output by the video recording unit 210, a selecting unit 230, configured to select at least one channel of data among multiple channels of video data output by the video recording unit 210, and an encoding unit 240, configured to encode data, including encoding the 3D video data selected by the selecting unit 230.

The apparatus for decoding a multi-view video, processing and displaying images includes a decoding unit 420, configured to decode the encoded data output by the encoding unit 240 and obtain the 3D video data, and an input control unit 410, located in the image display side of the 3D video data, and configured to send instructions including sending an instruction of recording a video at the specified view angle to the video recording unit 210 or collecting unit 220.

In other embodiments, the apparatus may further include a reconstructing unit 430, configured to reconstruct to obtain images for the 3D video data output by the decoding unit 420 according to the distance information sent by the input control unit 410.

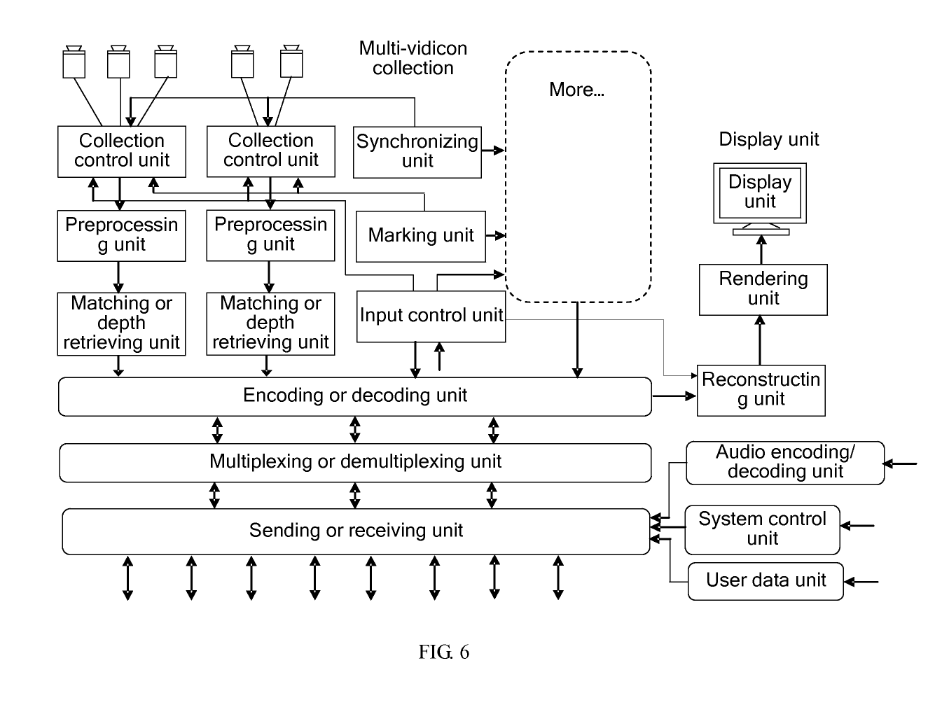

FIG. 6 is a system for recording a multi-view video and processing images in an embodiment of the present invention. The system includes an apparatus for recording a video and processing images and a display apparatus. The display apparatus includes an input control unit, configured to send instructions, including sending an instruction of recording a video at the specified view angle to the apparatus for recording a video and processing images, for example, an instruction of recording a video at one or more selected view angles, sending information about distance between the user and the display screen of the display unit to the reconstructing unit, sending information of the display mode of the display unit to the apparatus for recording a video and processing images, for example, information about whether or not supporting 2D display, binocular 3D display, or holographic display, and sending information about whether or not supporting adjusting the location of the video camera.

The input control unit receives the input from the terminal or the user, and sends instructions to the collection control unit, encoding unit, and/or reconstructing unit to control encoding and reconstruction of multi-view video streams. The foregoing information sent by the input control unit, for example, view angle, distance information, and display mode, may be input by the end user through a Graphic User Interface (GUI) or a remote control device. Or the foregoing information, for example, terminal display mode, distance detection, whether or not supporting reconstruction, may be detected by the terminal itself.

The display apparatus includes a receiving unit, a demultiplexing unit, a decoding unit, a reconstructing unit, a rendering unit, and a display unit, which are connected in sequence.

The receiving unit is configured to receive a packet, including receiving a packet and removing the protocol header of the packet, and obtaining encoded data.

The demultiplexing unit is configured to demultiplex the data received by the receiving unit.

The decoding unit is configured to decode the encoded data output by the demultiplexing unit and obtain video data.

The reconstructing unit is configured to reconstruct to obtain images for the 3D video data output by the decoding unit according to the distance information sent by the input control unit. The reconstructing unit mainly overcomes the problem of a change of the seen 3D image because of parallax change brought by location transfer, when the user watches the 3D images through an automatic 3D display. The automatic 3D display enables a user to see the 3D images without wearing glasses. In this case, however, the distance between the user and the automatic 3D display is changeable, which leads to change of the image parallax.

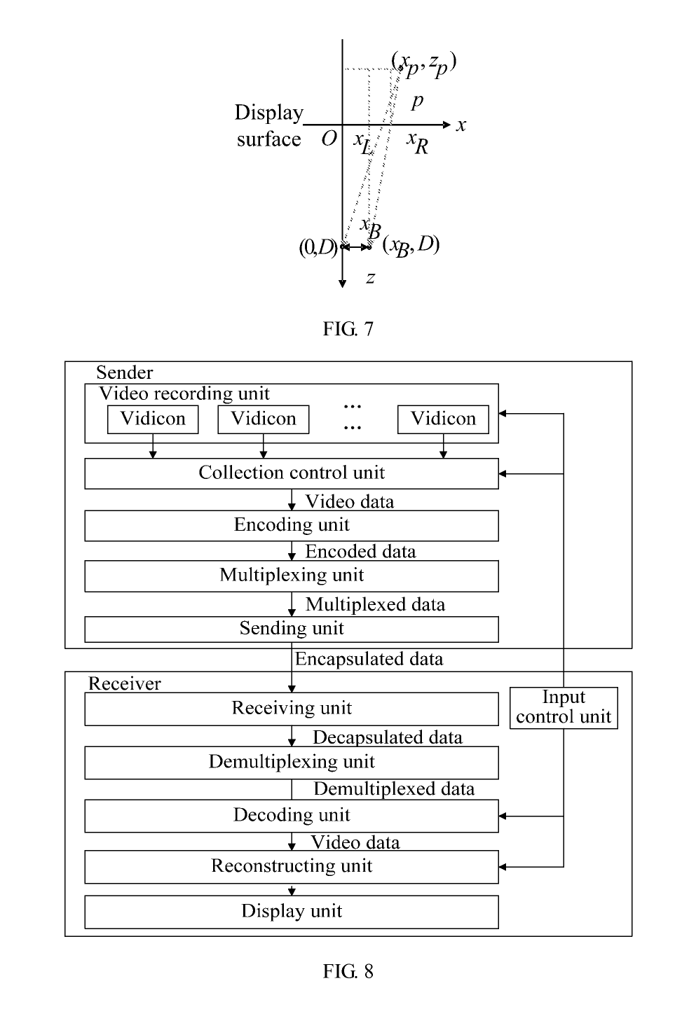

FIG. 7 shows relationships between image parallax p, object depth zₚ, and user-display distance D under a parallel video camera system. It can be derived according to simple geometrical relationships that:

$$\{ \begin{matrix}\frac{{x}_{L}}{D} = \frac{{x}_{p}}{D - {z}_{p}} \\ \frac{{x}_{R} - {x}_{B}}{D} = \frac{{x}_{p} - {x}_{B}}{D - {z}_{p}}\end{matrix} ⇒ \frac{{x}_{L} - {x}_{R} + {x}_{B}}{D} = \frac{{x}_{B}}{D - {z}_{p}} ⇒ \vert {x}_{L} - {x}_{R} \vert = {x}_{B} ( 1 - \frac{D}{D - {z}_{p}} ) = {x}_{B} ( \frac{1}{\frac{{z}_{p}}{D} - 1} + 1 ) = p$$

It can be seen from the formula above that the image parallax p depends on the distance D between the user and the display. The 3D video images received by the 3D video receiver generally have a fixed parallax, which may serve as a reference parallax p_{ref}. When D changes, the reconstructing unit needs to adjust the parallax p_{ref} accordingly and generate a new parallax p′, and generate another image according to the new parallax. In this way, proper images can be seen when the distance between the user and the display surface changes. The distance between the user and the display surface may be detected automatically according to a depth map calculated by the video camera, or controlled manually by the user through the input control unit. For example, the user may control the parallax of the reconstructed image through a remote controller so as that 3D images suitable for watching can be obtained within a certain location area.

The rendering unit is configured to render the data output by the decoding unit or the reconstructing unit to the 3D display device.

The display unit is configured to input video data and display video images. In this embodiment, the display unit may be an automatic 3D display.

The apparatus for recording a video and processing images includes a video recording unit, a collection control unit, a preprocessing unit, a matching or depth retrieving unit, an encoding unit, a multiplexing unit, and a sending unit, which are interconnected in sequence. In addition, the apparatus further includes a marking unit and a synchronizing unit, both connected with the collection control unit respectively.

The video recording unit is configured to record a video, including recording a multi-view video, namely, record a video of the same scene at different view angles, and output 3D video data.

The collection control unit is configured to control operations of the video recording unit, including controlling the video recording unit to record a video at the specified view angle according to the instruction for designating a view angle sent by the input control unit, and output the 3D video data. The detailed operations include controlling the video camera corresponding to the specified view angle of the video recording unit to record a video according to the received instruction for designating a view angle, and output the 3D video data; or controlling the video camera of the video recording unit and letting the video camera adjust itself to record a video at the specified view angle according to the received instruction for designating a view angle, and output the 3D video data; or controlling the video camera close to the specified view angle to record a video according to the received instruction for designating a view angle, and output the 3D video data.

The collection control unit may control a set of video cameras to collect and output video images. The number of the video cameras of the set of video cameras may be configured according to situations and requirements. If there is one video camera, the collection control unit outputs 2D video streams; if there are two video cameras, the collection control unit outputs binocular 3D video streams; when there are more than two video cameras, the collection control unit outputs multi-view video streams. For analog video cameras, the collection control unit needs to convert the analog image signals to digital video images. The images are stored in the buffer of the collection control unit in the form of frames.

In addition, the collection control unit sends the collected images to the marking unit for video camera marking. The marking unit returns the obtained internal parameter and external parameter of the video camera to the collection control unit. According to these parameters, the collection control unit sets up one-to-one relationships between the video streams and the attributes of the collecting video camera. The attributes include unique serial number of the video camera, the internal parameter and the external parameter of the video camera, and collection timestamp of each frame. The collection control unit outputs the video camera attributes and the video streams in a specific format. In addition to the foregoing functions, the collection control unit further provides a function of controlling the video camera and a function of image collection synchronizing. The collection control unit can perform operations such as translation, rotation, zoom-in and zoom-out through a remote control interface of the video camera according to the parameters marked by the video camera. The collection control unit may provide synchronous clock signals for the video camera through the synchronization interface of the video camera to control synchronous collection. In addition, the collection control unit can accept control of the input control unit, for example, shutting down video collection of unneeded video cameras according to the view angle information selected by the user, namely, control the video camera corresponding to the specified view angle of the video recording unit to record a video according to the instruction for designating a view angle received from the input control unit, or control the video camera of the video recording unit and letting the video camera adjust itself to record a video at the specified view angle according to the received instruction for designating a view angle, or control the video camera close to the specified view angle to record a video according to the received instruction for designating a view angle.

The synchronizing unit is configured to generate synchronization signals, input the synchronization signals to the video recording unit, and control the video recording unit to perform synchronous collection; or input the synchronization signals to the collection control unit, and notify the collection control unit to control the video recording unit to perform synchronization collection.

The marking unit is configured to obtain an internal parameter and an external parameter of the video camera in the video recording unit, and output the video camera location information such as location correction instruction to the collection control unit.

The preprocessing unit is configured to receive the 3D video data output by the collection control unit and the corresponding video camera parameters, and preprocesses the 3D video data according to a preprocessing algorithm.

The matching or depth retrieving unit is configured to derive 3D information of the imaging object from the images collected by the video camera or from the 3D video data output by the preprocessing unit, and output the 3D information together with the 3D video data to the encoding unit.

The encoding unit is configured to encode data, including encoding the 3D video data selected by the foregoing units. The encoding unit can also encode the 3D video data in the corresponding encoding mode according to the display mode information sent by the input control unit.

The encoding unit may be combined with the decoding unit as a codec unit, which is responsible for encoding and decoding multiple channels of video images. In this embodiment, the codec unit includes multiple types of codec, for example, traditional 2D image codec (H.263, H.264), codec that supports 2D image encoding and parallax or depth encoding, and coder that supports an MVC standard. When obtaining the display mode information sent by the input control unit, the 3D video data are encoded in the mode corresponding to the display mode. For example, an MVC standard is used to encode the data if the display mode is adaptable to the MVC.

As mentioned above, in this embodiment, the collection control unit and the video codec unit can receive reverse channel input from the input control unit, and control the collection and the encoding and decoding of the video images according to the information sent by a user through the input control unit. The basic control includes the following aspects.

(1) According to the view angle selected by the user, the collection control unit controls collection of video images of the video camera, for example, only collects the images can be seen from the view angle of the user and does not collect the video streams of other video cameras, thus reducing the load on the following codec unit. In addition, the collection control unit can control the video camera to adjust the video camera according to the view angle information, for example, move or rotate the video camera in order to collect the video images which do not previously belong to the view angle corresponding to the former location of the video camera.

(2) According to the view angle selected by the user, corresponding video streams are found for encoding. Video streams outside the view angle of the user are not encoded, thus processing load of the codec unit is reduced effectively.

(3) Video streams corresponding to the display mode of the user terminal are encoded and decoded. For example, one channel of 2D video stream is encoded and sent if a terminal only supports 2D display. In this way, the compatibility between the multi-view 3D video communication system and the ordinary video communication system is improved, and unnecessary data transmission is reduced.

The multiplexing unit is configured to multiplex the code data output by the encoding unit.

The sending unit is configured to encapsulate the code data output by the multiplexing unit into packets that comply with Real-time Transport Protocol (RTP), and transmit the packets through a packet-switched network.

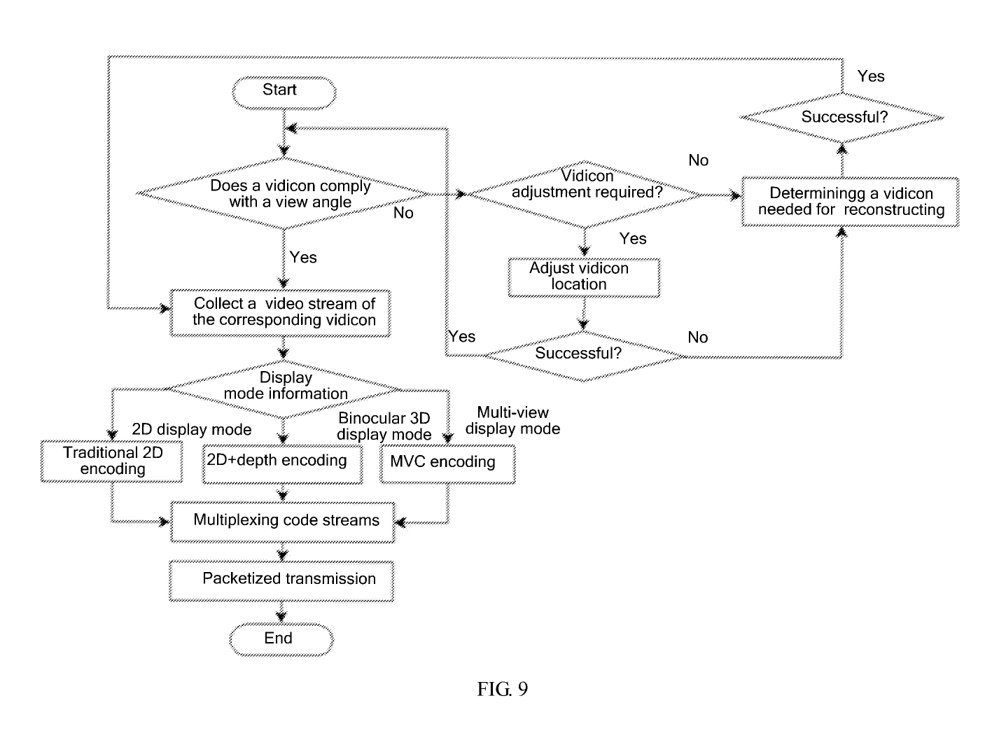

As shown in FIG. 8 and FIG. 9, when operating, the collection control unit controls collection of the video camera in the video recording unit, and outputs video streams. After undergoing a series of processing by the preprocessing unit and the matching or depth retrieving unit, the video streams arrive at the video encoding unit. The input control unit on the display apparatus side sends instructions through a reverse channel to control the video recording unit and/or collection control unit so that the video data from part of view angles are selected among multiple channels of video data output by the video recording unit, and sent to the encoding unit. Here the collection control unit may serve as a functional entity for selecting streams. The collection control unit receives instruction for designating a view angle from the input control unit through the reverse channel, and selects the video streams may include one of the following modes.

(1) Compare the view angle (viewpoint) information carried in the instruction for designating a view angle with the location information of each video camera controlled by the video recording unit, namely, match the view angle carried in the instruction for designating a view angle with the view angle information of each channel of data output by each video camera one by one, and obtain at least one channel of 3D video data corresponding to the specified view angle. If it is derived from the location information that the recording angle of the video camera complies with the view angle carried in the received instruction for designating a view angle, record a video at the specified view angle, namely, use this video camera to collect the video streams.

(2) If the view angle information carried in the instruction for designating a view angle does not comply with the location information of the video camera, namely, the view angle information of each channel of data does not match the view angle carried in the instruction for designating a view angle, a further judgment about whether the video camera location needs to be adjusted is needed. If determining that the video camera location needs to be adjusted, control the video camera of the video recording unit to adjust the video camera and record a video at the specified view angle. If the adjustment succeeds, go on with the photographing operation.

(3) If the adjustment of the video camera location is not supported or fails, namely, the video camera can not adjusted to the view angle carried in the instruction for designating a view angle, control the video camera close to the specified view angle to record a video according to the instruction for designating a view angle, and output the 3D video data. Meanwhile, send the data obtained from the video recording of the video camera close to the specified view angle, the internal parameter and external parameter of each video camera, and the collection timestamp to the encoding unit so that the images of the required view angle can be reconstructed out of the video images of other view angles on the receiver side.

If the multiple channels of video data, the internal parameter and external parameter of each video camera, and the collection timestamp are not output to the encoding unit, namely, if the images of the required view angle are not reconstructed on the receiver side, a image processing unit may be added on the video camera side. The image processing unit is configured to obtain virtual view angle data by reconstructing the data obtained from video recording by the video camera close to the specified view angle, and send the virtual view angle data to the encoding unit.

That is, a judgment is made first to check whether the recording angle of the video camera complies with the view angle carried in the instruction for designating a view angle. If the recording angle of the video camera complies with the view angle carried in the instruction for designating a view angle, this video camera is used to record a video; otherwise, a judgment is made about whether adjustment of the video camera is supported. If adjustment of the video camera is supported, the video camera location may be changed to collect the video images of the required view angle. If the required view angle is still unavailable after the video camera location is adjusted, the third reconstruction mode mentioned above may be applied to collect the view streams of the corresponding video camera.

After the video stream data is selected, the encoding unit encodes the selected video streams. If more than two channels of video streams are selected, the streams enter the multiplexing unit to be multiplexed, and then sent to the sending unit for packetizing. The packetized streams are transmitted through a network interface. As mentioned above, the encoding unit can encode the 3D video data in the corresponding encoding mode according to the display mode of the display unit on the display apparatus side.

The receiving unit on the display apparatus side receives the packetized streams, which are then processed and sent to the demultiplexing unit for demultiplexing. The demultiplexed streams are sent to the decoding unit for decoding to generate video stream images after decoding. If reconstruction is required, the reconstructing unit reconstructs the video stream images. The input control unit is located on the receiver side, and controls the collection control unit and/or the encoding unit on the sender side through a reverse channel. With respect to reconstruction, encoding, and decoding, because the receiver needs to collaborate with the sender, the input control unit may have a channel to control both the decoding unit and the reconstructing unit.

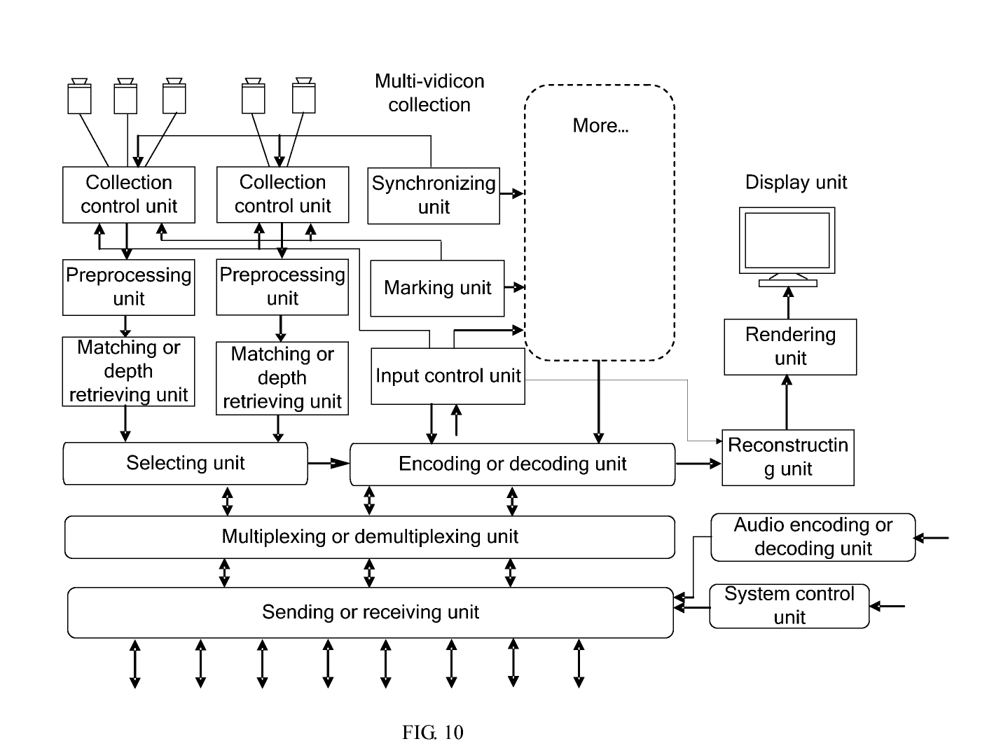

FIG. 10 shows a flow chart of controlling the encoding unit of the input control unit. The sender obtains video image streams from N video cameras, and needs to determine the video streams corresponding to the selected view angle (viewpoint) first. Because the collection control unit has recorded the view angle information of the video camera and a corresponding video stream, the collection control unit can locate the video stream according to the view angle (video camera location) information, namely, match the view angle information of each channel of data with the view angle carried in the instruction for designating a view angle (in the form of viewpoint identifier) one by one, and obtain the video data corresponding to the specified view angle. Afterward, the encoding unit determines the display mode information of the display unit on the display apparatus side, and selects the proper encoding mode according to the display mode information. For example, if the receiver only supports a 2D image display mode, the encoding unit encodes the video stream in a 2D mode, or performs 2D encoding for the 3D data according to a certain rule. For example, one of the left and right images is transmitted. If the display unit can display binocular 3D videos, the encoding unit may encode the video data according to the 2D image and depth or parallax image mode. If the display unit needs to simultaneously display multiple images whose view angles vary sharply, the encoding unit may encode the video data according to the MVC standard. The encoded video streams are sent to the multiplexing unit for multiplexing by frames or by scenes. The multiplexed data is transmitted in a packetized mode. Because the decoding unit is controlled by the input control unit like the encoding unit on the display apparatus side, the same encoding information can be obtained for decoding.

It is noteworthy that all units in the foregoing embodiments of the apparatus for recording a multi-view video and processing images can be integrated in a processing module. Likewise, all units in other embodiments of the system for recording a multi-view video and processing images can also be integrated in a processing module, or any two or more of the units in the foregoing embodiments can be integrated in a processing module.

In addition, every unit in the embodiment of the present invention may be implemented in the form of hardware, and the part suitable for being implemented through software may be implemented through software function modules. Accordingly, the embodiments of the present invention may be sold or used as independent products, and the part suitable for being implemented through software may be stored in computer-readable storage media for sale or use.

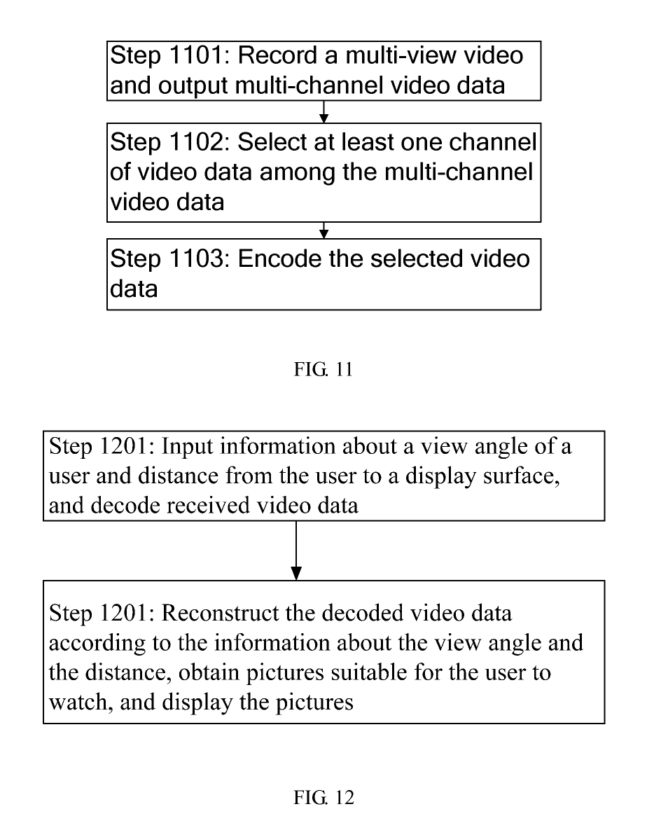

Referring to FIG. 11, the present invention also provides a method for recording a video and processing images in the first embodiment of the present invention. The method includes the following steps:

Step 1101: Record a multi-view video and output 3D video data.

Step 1102: Select at least one channel of data among the 3D video data.

Step 1103: Encode the selected 3D video data.

In other embodiments, step 1101 above may be: Record a video at the specified view angle according to the received instruction for designating a view angle, and output 3D video data, which is detailed below:

1) record a video at the specified view angle when the angle for the video recording complies with the specified view angle carried in the instruction for designating a view angle; or

2) set the angle for the video recording of the video camera according to the specified view angle carried in the instruction for designating a view angle, and record a video; or

3) control the video camera close to the specified view angle to record a video when the angle for the video recording does not comply with the specified view angle carried in the instruction for designating a view angle.

The details of step 1101 above may also be:

1) record a multi-view video, and output the 3D video data and the view angle information corresponding to each channel of data; and

2) match the view angle information of each channel of data with the view angle carried in the instruction for designating a view angle one by one according to the received instruction for designating a view angle, and obtain at least one channel of 3D video data corresponding to the specified view angle.

The details of step 1103 above may be: Encode the 3D video data in the corresponding encoding mode according to the display mode of the display unit which displays the 3D video data.

In other embodiments, the method may further include:

Step 1104: Input information about distance between the user and the display surface.

Step 1105: Reconstruct to obtain images out of the 3D video data according to the information about the distance.

Persons of ordinary skilled in the art may understand that all or part of the steps of the method for recording a video and processing images in the embodiments of the present invention may be implemented by a program instructing relevant hardware. The program may be stored in a computer-readable storage medium. When being executed, the program can perform contents of the steps of the method in each embodiment of the present invention. The storage media may be ROM/RAM, magnetic disk, or compact disk.

As shown in FIG. 12, a method for decoding videos and processing images in an embodiment of the present invention includes the following steps:

Step 1201: Input information about a view angle of a user and distance from the user to a display surface, and decode received 3D video data.

Step 1202: Reconstruct images for the decoded 3D video data according to the information about the view angle and the distance, and obtain images suitable for the user to watch, and display the images.

The step of inputting information about a view angle of a user and distance from the user to a display surface includes: The user manually inputs, or the system automatically detects the information about the view angle of the user and the distance between the user and the display surface.

The step of decoding received 3D video data includes decoding the 3D video data in the corresponding decoding mode according to the information about the view angle for displaying the 3D video data and the display mode of the display unit.

In conclusion, embodiments of the present invention bring at least the following technical effects:

(1) The video image collecting unit or the encoding unit is controlled to select the video data at the view angles required by the user for encoding, thus improving efficiency of collection and encoding and lowering the requirement processing capability of the system.

(2) Only the video data recorded at the view angles required by the user are collected, encoded, and transmitted, thus efficiencies of processing and transmission are improved at a maximum and quality of real-time transmission is ensured.

(3) The encoding mode of the sender is controlled to according to the display mode capable to be watched by the user, thus complexity of the system is lessened and availability of the system is improved.

In the conventional art, the MVC video images need to be displayed in multiple modes such as 2D display, 3D display, and holographic display, etc. Data type of each display mode differs from one another, so is for encoding mode. However, the processing system in the conventional art does not support encoding MVC video images according to a display type. The embodiments of the present invention solve this technical problem commendably.

(4) The 3D images can be reconstructed according to the information about distance between the user and the display surface, thus image display of higher quality is realized.

The user location detection method in the conventional art is not reliable, but the 3D image reconstruction is highly related to the watching position of the user (that is, the distance between the user and the display surface).

Elaborated above are an apparatus, a system, and a method for recording a multi-view video and processing images, and a decoding processing method in preferred embodiments of the present invention. The foregoing embodiments are only intended to help understand the method and ideas of the present invention. Although the invention is described through some embodiments, the invention is not limited to such embodiments. It is apparent that those skilled in the art can make modifications and variations to the invention without departing from the scope of the invention. The invention is intended to cover such modifications and variations provided that they fall in the scope of protection defined by the following claims or their equivalents.

What is claimed is:

1. An apparatus for recording a multi-view video and processing images, the apparatus comprising:
a video recording unit comprising at least two video cameras, and each video camera is configured to record video data at a designated view angle;
a selecting unit configured to control the video recording unit to record the video data at the designated view angle according to a received instruction for recording video data at the designated view angle, and output at least one channel of three-dimensional (3D) video data;
an encoding unit configured to encode the least one channel of 3D video data.

2. The apparatus for recording a multi-view video and processing images according to claim 1, wherein the selecting unit is specifically configured to:
control a video camera of the video recording unit, which is corresponding to the designated view angle, to record video data according to the received instruction for recording video data at the designated view angle, and output the 3D video data.

3. The apparatus for recording a multi-view video and processing images according to claim 1, wherein the selecting unit is specifically configured to:
control a video camera of the video recording unit to adjust recording angle of the video camera and record video data at the designated view angle according to the received instruction for recording video data at the designated view angle, and output the 3D video data.

4. The apparatus for recording a multi-view video and processing images according to claim 1, wherein the selecting unit is specifically configured to:
control a video camera whose recording angle is close to the designated view angle to record video data according to the received instruction for recording video data at the designated view angle, and output the 3D video data.

5. The apparatus for recording a multi-view video and processing images according to claim 4, comprises a collecting unit which is configured to collect the 3D video data output by the video recording unit, wherein:
the collecting unit is configured to send video data obtained from the video camera whose recording angle is close to the designated view angle, an internal parameter and an external parameter of each video camera, and a collection timestamp to the encoding unit.

6. The apparatus for recording a multi-view video and processing images according to claim 4, comprises a collecting unit which is configured to collect the 3D video data output by the video recording unit, wherein the collecting unit further comprises:
a image processing sub-unit configured to reconstruct data obtained from the video camera whose recording angle is close to the specified view angle, obtain virtual view angle data, and send the virtual view angle data to the encoding unit.

7. The apparatus for recording a multi-view video and processing images according to claim 1, wherein:
the encoding unit is specifically configured to select an encoding mode according to a received instruction for recording video data at the designated view angle from a user and a received instruction of a display mode of a display unit which displays the 3D video data, and encode the 3D video data by using the selected encoding mode, wherein the display mode is two-dimensional (2D) display, binocular 3D video display, or multi-view video display.

8. A system for recording a multi-view video and processing images, the system comprising an apparatus for recording a multi-view video and processing images and an apparatus for decoding a multi-view video, processing and displaying images which is interconnected with the apparatus for recording a multi-view video and processing images; wherein:
the apparatus for recording a multi-view video and processing images is configured to record video data at a designated view angle according to a received instruction for recording video data at the designated view angle, and obtain at least one channel of the three-dimensional (3D) video data, encode the at least one channel of the 3D video data, and send the encoded at least one channel of the 3D video data to an apparatus for decoding a multi-view video, processing and displaying images; and
the apparatus for decoding a multi-view video, processing and displaying images is configured to send an instruction for recording video data at the designated view angle to the apparatus for recording a multi-view video and processing images, and decode the encoded at least one channel of the 3D video data received from the apparatus for recording a multi-view video and processing images.

9. The system for recording a multi-view video and processing images according to claim 8, wherein the apparatus for decoding a multi-view video, processing and displaying images comprises:
an input control unit which is configured to send instructions, comprising sending the instruction for recording video data at the designated view angle to the apparatus for recording a multi-view video and processing images;
a decoding unit which is configured to decode the encoded at least one channel of 3D video data received from the apparatus for recording a multi-view video and processing images.

10. The system for recording a multi-view video and processing images according to claim 9, wherein the apparatus for decoding a multi-view video, processing and displaying images further comprises a reconstructing unit, wherein
the input control unit is further configured to send distance information about distance between the user and the display screen of the display unit to the reconstructing unit; and
the reconstructing unit is configured to reconstruct images by using the 3D video data output by the decoding unit according to the distance information received from the input control unit.

11. A method for recording video data and processing images, the method comprising:
receiving instruction for recording video data at a designated view angle;
controlling a video camera to record video data at the designated view angle according to the received instruction for recording video data at a designated view angle and obtaining at least one channel of three-dimensional (3D) video data; and
encoding the at least one channel of 3D video data.

12. The method for recording a video and processing images according to claim 11, wherein the process of controlling a video camera to record video data at the designated view angle according to the received instruction for recording video data at the designated view angle comprises:
determining whether a recording angle of the video camera is complies with a view angle carried in the instruction for recording video data at the designated view angle; and
controlling the video camera to record video data at the designated view angle when the recording angle of the video camera is complies with the view angle carried in the instruction.

13. The method for recording a video and processing images according to claim 11, wherein the process of controlling a video camera to record video data at the designated view angle according to the received instruction for recording video data at the designated view angle comprises:
setting a recording angle of a video camera in accordance with a view angle carried in the instruction for recording video data at the designated view angle, and recording the video data at the designated view angle.

14. The method for recording a video and processing images according to claim 11, wherein the process of controlling a video camera to record video data at the designated view angle according to the received instruction for recording video data at the designated view angle comprises:
determining whether a recording angle of the video camera is complies with a view angle carried in the instruction for recording video data at the designated view angle;
controlling a video camera whose recording angle is close to the designated view angle to record video data if the recording angle of the video camera does not comply with the view angle carried in the received instruction; and further comprises:
obtaining an internal parameter and an external parameter of each video camera, and a collection timestamp; and
encoding the internal parameter and the external parameter of each video camera, and the collection timestamp.

15. The method for recording a video and processing images according to claim 11, wherein the process of controlling a video camera to record video data at the designated view angle according to the received instruction for recording video data at the designated view angle comprises:
determining whether a recording angle of the video camera is complies with a view angle carried in the instruction for recording video data at the designated view angle;
controlling a video camera whose recording angle is close to the designated view angle to record video data if the recording angle of the video camera does not comply with the view angle carried in the received instruction; and
the process of encoding the at least one channel of 3D video data comprises:
reconstructing the 3D video data obtained from the video camera whose recording angle is close to the designated view angle to obtain virtual view angle data; and
encoding the virtual view angle data.

16. The method for recording a video and processing images according to claim 11, wherein the encoding the least one channel of 3D video data comprises:
selecting an encoding mode according to a received instruction for recording video data at a designated view angle from a user and a received instruction of a display mode of a display unit which displays the 3D video data;
encoding the 3D video data by using the selected encoding mode, wherein the display mode is two-dimensional (2D) display, binocular 3D video display, or multi-view video display.
